(19) United States
(12) Patent Application Publication
(10) Pub. No.: US 2025/0068985 A1
(43) Pub. Date: Feb. 27, 2025

(54) CLUSTERING APPARATUS, METHOD, AND STORAGE MEDIUM

(71) Applicant: KABUSHIKI KAISHA TOSHIBA, Tokyo (JP)

(72) Inventors: Shuhei NITTA, Tokyo (JP); Shun HIRAO, Kawasaki Kanagawa (JP); Yasutaka FURUSHO, Fuchu Tokyo (JP)

(73) Assignee: KABUSHIKI KAISHA TOSHIBA, Tokyo (JP)

(21) Appl. No.: 18/810,938

(22) Filed: Aug. 21, 2024

(30) Foreign Application Priority Data
Aug. 22, 2023 (JP) 2023-134786

(51) Int. Cl. G06N 20/20

(52) U.S. Cl. CPC G06N 20/20

(57) ABSTRACT

A clustering apparatus includes processing circuitry. The processing circuitry is configured to: acquire target data, a first trained model adapted to receive input of the target data and output a first feature vector, and a second trained model adapted to receive input of the target data and output a second feature vector; calculate the first feature vector using the first trained model and the target data; calculate the second feature vector using the second trained model and the target data; calculate a second cluster by dividing the second feature vector; and integrate the first feature vector with the second cluster.

### CROSS-REFERENCE TO RELATED APPLICATIONS

This application is based upon and claims the benefit of priority from Japanese Patent Application No. 2023-134786, filed Aug. 22, 2023, the entire contents of which are incorporated herein by reference.

### FIELD

Embodiments described herein relate generally to a clustering apparatus, a method, and a storage medium.

### BACKGROUND

A clustering apparatus is an apparatus configured to perform classification (also referred to as “cluster division” or “clustering”) on target data (also referred to as “pieces of target data”) which is a vector data group by using a trained model. For example, a clustering apparatus dimensionally compresses a vector data group using a method such as t-SNE, estimates the number of clusters, and performs classification on the dimensionally compressed vector data group using a trained model. A trained model identifies a cluster level (cluster ID) by, for example, an unsupervised training method. Such a cluster level (cluster ID) identified by a trained model is used as, for example, training data in supervised training for another trained model.

Generally, a data group targeted for clustering may include data harmful to clustering (hereinafter referred to as “harmful data”). Examples of data harmful to clustering include unidentifiable data and noisy data mixed in by mistake. Examples of unidentifiable data include data which more than 90% of people cannot correctly identify. For example, in the case of classifying a group of photos showing animals into two clusters, “dog” and “cat”, the group of photos may include, as unidentifiable data, an image in which an unidentifiable portion is enlarged, an image in which both a dog and a cat are shown, etc. Furthermore, as noisy data, images of a “horse”, a “vehicle”, etc., which have been mixed by mistake into a group of photos may be included in a group of photos serving as target data.

Such pieces of harmful data may hinder correct clustering and become a factor that reduces clustering performance. In addition, such pieces of harmful data may obscure a boundary between clusters or form an unessential spurious cluster in a case of displaying feature vectors output from a trained model, thereby being a factor that reduces visibility of clustering results.

### BRIEF DESCRIPTION OF THE DRAWINGS

FIG. 1 is a diagram showing a configuration example of a clustering apparatus according to a first embodiment.

FIG. 2 is a flowchart showing an example of a processing procedure in display processing by the clustering apparatus according to the first embodiment.

FIG. 3 is a scatter diagram showing first feature vectors in accordance with first clusters.

FIG. 4 is a scatter diagram showing second feature vectors in accordance with second clusters.

FIG. 5 is a scatter diagram showing first feature vectors in accordance with the second cluster.

FIG. 6 is a diagram showing a configuration example of a clustering apparatus according to a second embodiment.

FIG. 7 is a flowchart showing an example of a processing procedure in display processing by the clustering apparatus according to the second embodiment.

FIG. 8 is a diagram showing a configuration example of a clustering apparatus according to an application example.

### DETAILED DESCRIPTION

In general, according to one embodiment, a clustering apparatus includes processing circuitry. The processing circuitry is configured to: acquire target data, a first trained model adapted to receive input of the target data and output a first feature vector, and a second trained model adapted to receive input of the target data and output a second feature vector; calculate the first feature vector using the first trained model and the target data; calculate the second feature vector using the second trained model and the target data; calculate a second cluster by dividing the second feature vector; and integrate the first feature vector with the second cluster.

Hereinafter, embodiments of a clustering apparatus, a method, and a storage medium will be described in detail with reference to the drawings. In the description below, structural elements having substantially the same functions will be denoted by the same reference symbols, and repeat descriptions of such elements will be given only where necessary.

### First Embodiment

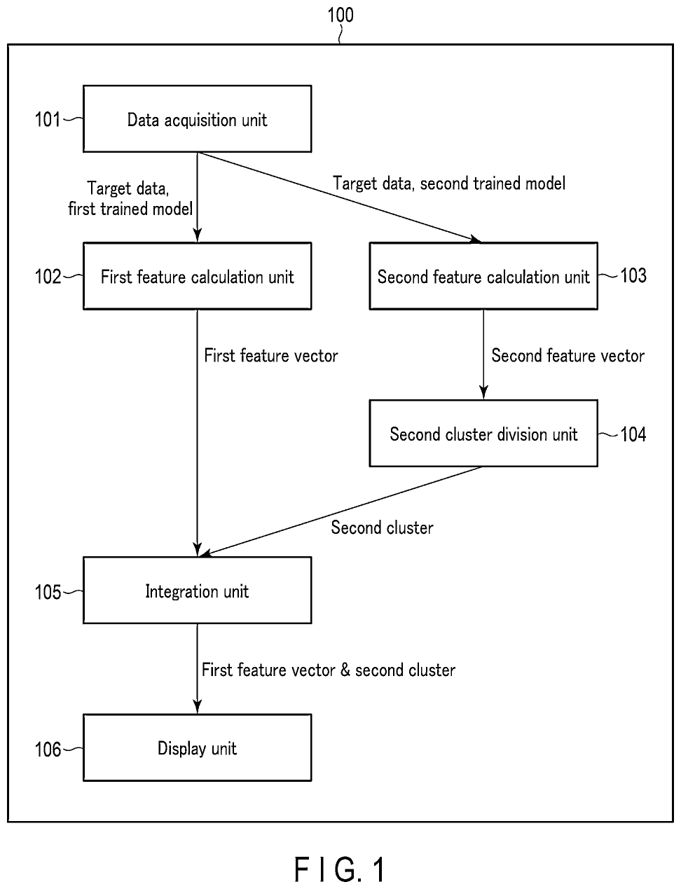

FIG. 1 is a diagram showing a configuration of a clustering apparatus 100 according to a first embodiment. The clustering apparatus 100 is an apparatus configured to display output from a first trained model in order to check clustering performance of classification (also referred to as “cluster division” or “clustering”) using the first trained model.

The clustering apparatus 100 includes a data acquisition unit 101, a first feature calculation unit 102, a second feature calculation unit 103, a second cluster division unit 104, an integration unit 105, and a display unit 106.

The data acquisition unit 101 acquires target data, the first trained model, and a second trained model.

Target data is data targeted for clustering. Examples of target data include image data. For example, in a case where a group of images showing animals is divided (clustered) by animal type, the target data correspond to the images showing animals. The target data is not limited to image data and may be data in other formats as long as the data serves as a target for clustering.

To support clustering in consideration of harmful data, the present embodiment aims to improve clustering performance of the first trained model and visibility of clustering results. The second trained model is a machine learning model used as an auxiliary to improve the performance or visibility of the first trained model. As the first trained model and the second trained model, for example, a general machine learning model used for clustering a data group, such as a deep neural network (DNN), can be used.

The first trained model receives input of target data and outputs a first feature vector. That is, the first trained model is a machine learning model that converts target data into the first feature vector. The second trained model receives input of target data and outputs second feature vector. That is, the second trained model is a machine learning model that converts target data into the second feature vector. The second feature vectors output from the second trained model are auxiliarily used to improve the clustering performance of the first feature vectors and the visibility of clustering results.

The second trained model is a machine learning model different from the first trained model. Therefore, even in a case where the same target data is input to each of the first trained model and the second trained model, an output result may be different between the first trained model and the second trained model. For example, in a case where the same target data is input to each of the first trained model and the second trained model, the first feature vector output from the first trained model and the second feature vector output from the second trained model may be different from each other. As the second trained model, it is preferable to use a model that has a small difference in clustering performance from the first trained model and has a different output tendency from the first trained model. Examples of a model that has a different output tendency include a model which captures data in a different way. For example, the second trained model is a machine learning model that differs from the first trained model in at least one of the model architecture, the training method, the hyperparameter during training, and the data set during training.

Examples of the model architecture include an architectural parameter such as the number of layers, the number of channels, etc., and a type of model architecture such as ResNet/MobileNet/EfficientNet. Examples of the training method include ID, IDFD, simCLR, MOCO, BYOL, BallowTwins, tSNE, UMAP, AE, and VAE. Examples of the hyperparameter during training include an optimizer, a learning rate, a learning rate schedule, the number of times of updating, a batch size, a loss function, and a random seed value. Examples of the loss function include a regularization strength (FD, Weight Decay, etc.), a temperature parameter, and a momentum coefficient. Examples of the data set during training include CIFAR-10 and ImageNet. The model architecture may also be called a training method.

The present embodiment will describe an example in which an unsupervised trained model (DNN) based on IDFD is used as the first trained model, and a DNN trained with a random number seed value changed from that of the first trained model is used as the second trained model. The above example is not a limitation, and the first trained model and the second trained model may differ in at least one of the elements described above.

The first feature calculation unit 102 calculates the first feature vector using the first trained model and the target data. At this time, the first feature calculation unit 102 inputs the target data into the first trained model and acquires the first feature vector output from the first trained model.

The second feature calculation unit 103 calculates the second feature vector using the second trained model and target data. At this time, the second feature calculation unit 103 inputs the target data into the second trained model and acquires the second feature vector output from the second trained model.

The second cluster division unit 104 performs clustering by dividing the second feature vectors into clusters and calculating second clusters. For clustering, a general clustering method such as a k-means can be used. Various methods such as a centroid method and kernel density estimation can be applied to clustering.

As the number of clusters divided by clustering (hereinafter referred to as a “cluster number”), for example, a numerical value specified by a user of the clustering apparatus 100 can be used. In a case of referring to the scatter diagram of the second feature vectors in a space dimensionally compressed using a method such as PCA, tSNE, UMAP, etc., or a case in which a cluster number can be estimated in advance from the nature of data, a corresponding numeric value may be used as a cluster number.

The integration unit 105 integrates the first feature vectors with the second clusters. In the present embodiment, the integration unit 105 associates a first feature vector and a second cluster, which are obtained from the same target data, thereby integrating the first feature vector and the second cluster with each other.

In order to check the performance of the first trained model, the display unit 106 visualizes and displays output of the first trained model. The display unit 106 displays the scatter diagram in which the first feature vectors output from the first trained model are mapped. At this time, the display unit 106 displays the first feature vectors output from the first trained model based on an integration result by the integration unit 105. Furthermore, the display unit 106 displays each first feature vector based on an index of its corresponding second cluster in the scatter diagram in which the first feature vectors are mapped. For example, the display unit 106 changes the color, size, shape, transparency, etc. of the first feature vector depending on the second cluster.

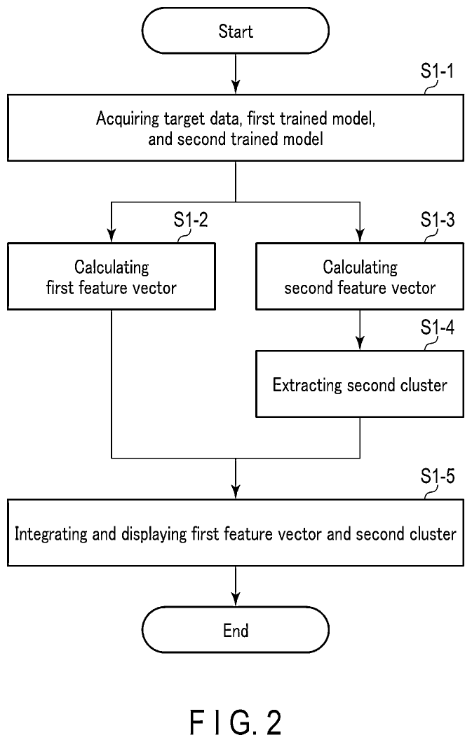

Next, operation in display processing executed by the clustering apparatus 100 according to the present embodiment will be described. FIG. 2 is a flowchart showing an example of a processing procedure in the display processing. The display processing is processing of displaying a scatter diagram in which the first feature vectors output from the first trained model are mapped, in order to allow the performance of the first trained model to be checked. Herein, as an example, a case will be described in which images showing one of the multiple types of animals are used as target data, and the images are each clustered for each animal type without using teacher label information.

The processing procedure in each instance of processing described below is merely an example, and each instance of processing can be appropriately changed where possible. Furthermore, with respect to the processing procedure described below, steps can be omitted, replaced, and added as appropriate according to the embodiment.

### (Display Processing)

### (Step S1-1)

First, the data acquisition unit 101 acquires a target data group including a plurality of pieces of target data, the first trained model, and the second trained model.

The target data group is an image group input as images showing animals. It is assumed that each image is a color image with an image size of 32×32 [pixel]. In this case, each piece of target data is image data of 3072 (=32×32×3) dimensional vectors, and the target data group is a vector data group of 3072 (=32×32×3) dimensional vectors.

### (Step S1-2)

Next, the first feature calculation unit 102 inputs each piece of target data into the first trained model, and acquires the first feature vector output from the first trained model, thereby calculating the first feature vector. It is assumed that the number of dimensions of the first feature vector is 128.

### (Step S1-3)

Next, the second feature calculation unit 103 inputs each piece of target data into the second trained model, and acquires the second feature vector output from the second trained model, thereby calculating the second feature vector. It is assumed that the number of dimensions of the second feature vector is 128.

### (Step S1-4)

Next, the second cluster division unit 104 calculates the second clusters obtained by clustering the second feature vectors calculated by the second feature calculation unit 103. At this time, the second cluster division unit 104 divides the respective second feature vectors into clusters in 30 categories using an unsupervised clustering method such as a k-means.

### (Step S1-5)

The integration unit 105 integrates the first feature vectors calculated in the processing at step S1-2 with the second clusters extracted in the processing at step S1-4. At this time, the integration unit 105 extracts, for each of the first feature vectors, the second feature vector calculated from the same target data and the second cluster into which the aforementioned second cluster has been classified, and associates the aforementioned first feature vector with the extracted second cluster. Thereafter, the display unit 106 displays a scatter diagram in which the first feature vectors are mapped based on the integration result. At this time, the display unit 106 displays each first feature vector such that its associated second cluster can be identified. For example, the display unit 106 displays the first feature vectors by changing the color, shape, size, transparency, etc., of each point indicating each first feature vector according to the corresponding second cluster. A user can check the clustering performance using the first trained model by checking the displayed scatter diagram.

### Advantageous Effect of First Embodiment

The advantageous effects of the clustering apparatus 100 according to the present embodiment will be described below.

The clustering apparatus 100 according to the present embodiment includes the data acquisition unit 101, the first feature calculation unit 102, the second feature calculation unit 103, the second cluster division unit 104, and the integration unit 105. The data acquisition unit 101 receives data piece, the first trained model that receives input of the target data and outputs the first feature vector, and the second trained model that receives input of the target data and outputs the second feature vector. For example, the first trained model and the second trained model differ from each other in a model architecture, a training method, a hyperparameter during training, or a data set during training. The first feature calculation unit 102 calculates the first feature vector using the first trained model and the target data. The second feature calculation unit 103 calculates the second feature vector using the second trained model and the target data. The second cluster division unit 104 calculates the second clusters by dividing the second feature vectors. The integration unit 105 integrates the first feature vectors with the second clusters. The clustering apparatus 100 according to the present embodiment further includes the display unit 106 configured to display each first feature vector based on the index of the corresponding second cluster. The display unit 106 displays the scatter diagram in which the first feature vectors output from the first trained model are mapped. The displayed scatter diagram corresponds to visualization of output from the first trained model. By checking the scatter diagram of the first feature vectors assigned information on the second clusters, a user can check whether input target data has been correctly identified or not. Accordingly, the user can accurately check the performance of the first trained model.

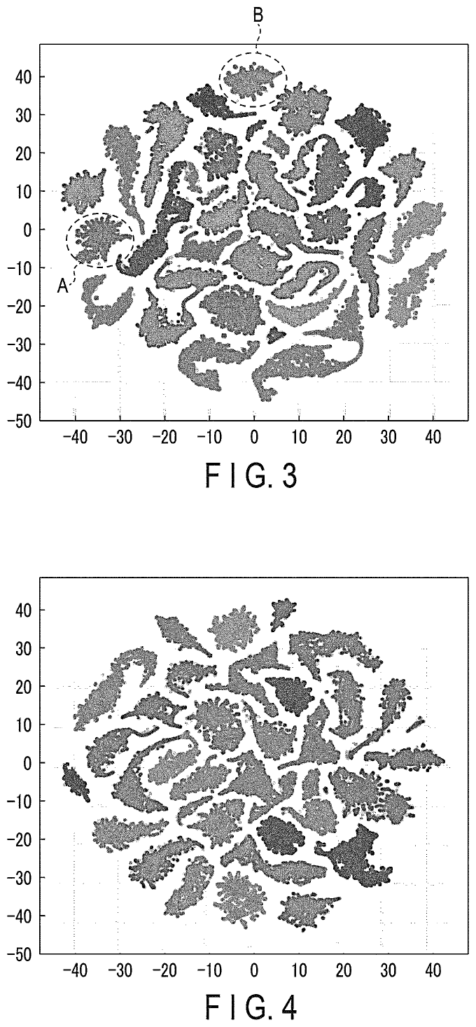

Herein, a method for checking the performance of a trained model through display according to the present embodiment will be explained in detail using the examples shown in FIG. 3 to FIG. 5.

FIG. 3 is an example of a scatter diagram in which the first feature vectors are mapped. FIG. 3 shows the 128-dimensional first feature vectors compressed into two dimensions for visualization. As a compression method, methods such as PCA, tSNE, and UMAP can be employed. In FIG. 3, for the sake of explanation, the first feature vectors are divided into a plurality of first clusters using a known clustering method, and a display method of the first feature vectors is changed depending on the first cluster. However, the display processing according to the present embodiment may not perform calculation of the first cluster. In FIG. 3, a pixel value (color density) of each point indicating each first feature vector is changed and displayed according to the corresponding first cluster.

FIG. 4 is an example of a scatter diagram in which the second feature vectors are mapped. FIG. 4 shows the 128-dimensional second feature vectors compressed into two dimensions for visualization. As a compression method, methods such as PCA, tSNE, and UMAP can be employed. In FIG. 4, a pixel value (color density) of each point indicating each second feature vector is changed and displayed according to the corresponding second clusters.

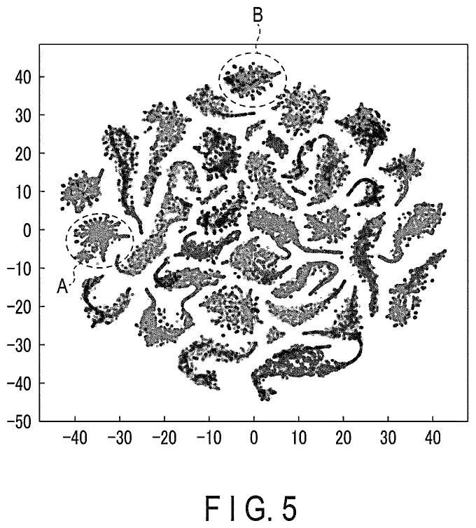

FIG. 5 is a scatter diagram in which the first feature vectors output from the first trained model displayed on the display unit 106 are mapped. FIG. 5 is generated based on an integration result of the first feature vectors shown in FIG. 3 and the second clusters shown in FIG. 4. FIG. 5 shows the 128-dimensional first feature vectors compressed into two dimensions for visualization. As a compression method, methods such as PCA, tSNE, and UMAP can be employed. In FIG. 5, each of the first feature vectors mapped in a similar manner to those in the scatter diagram of FIG. 3 is displayed in a manner such that the second cluster including the second feature vector generated from the same target data can be identified. In FIG. 5, a pixel value (color density) of each point indicating each first feature vector is changed and displayed according to the corresponding second cluster. Each point indicating each first feature vector may be changed in terms of its color, shape, size, transparency, etc., depending on the corresponding second cluster.

In a case where a plurality of pieces of target data which belong to one cluster belong to the same one cluster even through cluster division using another trained model, these pieces of target data are often data that can be easily clustered. For example, in a case of clustering animal species shown in images, data that can be easily clustered is an image that allows 90% or more of people to correctly classify the animal species shown therein.

On the other hand, in a case where a plurality of pieces of target data which belong to one cluster belong to another cluster through another trained model, these pieces of target data are often harmful data unsuitable for clustering. For example, a plurality of pieces of target data which belong to a single cluster generated using the first trained model may belong to multiple clusters as a result of clustering using the second trained model. In such a case, there is no consistency in cluster IDs of the second clusters. Thus, in a scatter diagram showing the first feature vectors and the second clusters in an integrated manner, a cluster in which a plurality of cluster IDs are mixed occurs in clusters. Such a cluster exhibits a low reproducibility of a clustering result, thereby being highly likely to be a pseudo cluster composed of harmful data unsuitable for clustering.

For example, as shown in FIG. 3, it can be seen that the first feature vectors included in region “A” belong to the same first cluster. Furthermore, as shown in FIG. 5, it can be seen that the first feature vectors included in region “A” belong to the same second cluster. By checking the display shown in FIG. 5, a user can consider the first feature vectors included in the region “A” as data that can be easily clustered.

On the other hand, as shown in FIG. 3, it can be seen that the first feature vectors included in region “B” belong to the same first cluster. However, as shown in FIG. 5, it can be seen that the first feature vectors included in the region “B” belong to the plurality of second clusters. By checking the display shown in FIG. 5, the user can consider that the first feature vectors included in the region “B” are likely to be harmful data, and that the cluster formed in the region “B” is a pseudo cluster composed of harmful data.

In this manner, a user can grasp harmful data included in target data by checking the reproducibility of clustering results using a plurality of trained models by a method of displaying integrated results such as those shown in FIG. 5. This allows the user to analyze the performance of the first trained model in consideration of the harmful data. For example, in a case where a plurality of cluster IDs are present within a single cluster, the user can consider this cluster as a pseudo cluster composed of harmful data, and discuss and analyzes clustering results without considering the pseudo cluster. Therefore, by auxiliarily using output of the second trained model different from the first trained model, the visibility of clustering results of the first trained model can be improved. That is, by providing the clustering apparatus 100 using the first trained model with information on clustering results of the second trained model different from the first trained model, the visibility of clustering results can be improved, thereby making it easier to confirm the clustering performance of the first trained model. For example, a user can efficiently discuss and analyze clustering results by checking a scatter diagram of the first feature vectors each displayed in an identifiable manner according to the correspond second cluster. Furthermore, the user can visually grasp a pattern of each cluster formed on the scatter diagram of the first feature vectors. Therefore, even with an increased amount of target data, the user can easily and efficiently investigate what image pattern each cluster formed on the scatter diagram forms.

It is preferable that a machine learning model similar in clustering performance to and different in output tendency from the first trained model be used as the second trained model.

The present embodiment described the case in which a DNN trained by changing the random number Seed value of the first trained model is used as the second trained model. This method is a method with the least difference in training conditions between the second trained model and the first trained model. Target data whose clustering result is changed simply by changing the random number Seed value is highly likely to be harmful data. Therefore, use of the second trained model described above enables reduction in influence of obvious harmful data whose clustering tendency changes depending on the initial value of a weight of a DNN and the order of training data.

Furthermore, a DNN changed in terms of an architectural parameter such as the number of layers and the number of channels of the first trained model may be used as the second trained model. In such a case, since the first trained model and the second trained model are different from each other in terms of representation capability and reference range for input, a model that is different from the first trained model in terms of approach with respect to data resolution and complexity is usable as the second trained model. With respect to each piece of target data, a user can grasp whether it is data suitable for clustering, which exhibits a clustering result which remains unchanged even after using a plurality of models that extract features from different viewpoints, or is harmful data whose clustering result changes.

Furthermore, a DNN generated using a training method different from that of the first trained model may be used as the second trained model. For example, according to a training method such as BYOL or Ballow Twins, training is performed using positive pairs. Such a training method treats its data, even after it is transformed, as a positive example (same class). Therefore, a model trained using a training method such as BYOL or Ballow Twins ends up being a model that considers only the positive pairs. On the other hand, according to a training method such as ID, IDFD, or simCLR, training is performed using negative pairs. Such a training method treats, even if its data is transformed, data other than its data as a negative example (different class). Therefore, a model trained using a training method such as ID, IDFD, or simCLR ends up being a model that considers the negative pairs, too. For example, one of the first training model and the second training model is set as a model trained using a training method such as BYOL or BallowTwins, and the other is set as a model trained using a training method such as ID, IDFD, or simCLR. This enables use of both the model that considers only the positive pairs and the model that considers the negative pairs, too. Even in this case, with respect to each piece of target data, a user can grasp whether it is data suitable for clustering, which exhibits a clustering result which remains unchanged even after using a plurality of models that extract features from different viewpoints, or is harmful data whose clustering result changes.

Furthermore, a dimension compression method such as tSNE or UMAP is a method that considers a distance in data between an input space and a compressed space. On the other hand, a dimension compression method such as AE or VAE is a method that considers the capability of reconstruction from the compressed space to the input space. For this reason, one of the first trained model and the second trained model is set as a model using a dimension compression method such as tSNE or UMAP, and the other is set as a model trained using a training method such as a dimension compression method such as AE or VAE. This enables use of both the model that considers a distance in data between the input space and the compressed space, and the model that considers the ability of reconstruction from the compressed space to the input space. Even in this case, with respect to each piece of target data, a user can grasp whether it is data suitable for clustering, which exhibits a clustering result which remains unchanged even after using a plurality of models that extract features from different viewpoints, or is harmful data whose clustering result changes.

### Second Embodiment

A second embodiment will be described. The present embodiment corresponds to the first embodiment modified in configuration as described below. The descriptions of the same configurations, operations, and effects as those of the first embodiment are omitted. The clustering apparatus 100 according to the present embodiment calculates first clusters after cluster division using the first training model, calculates a degree of mixing of the second clusters in each first cluster, and highlights the first feature vectors according to the degree of mixing.

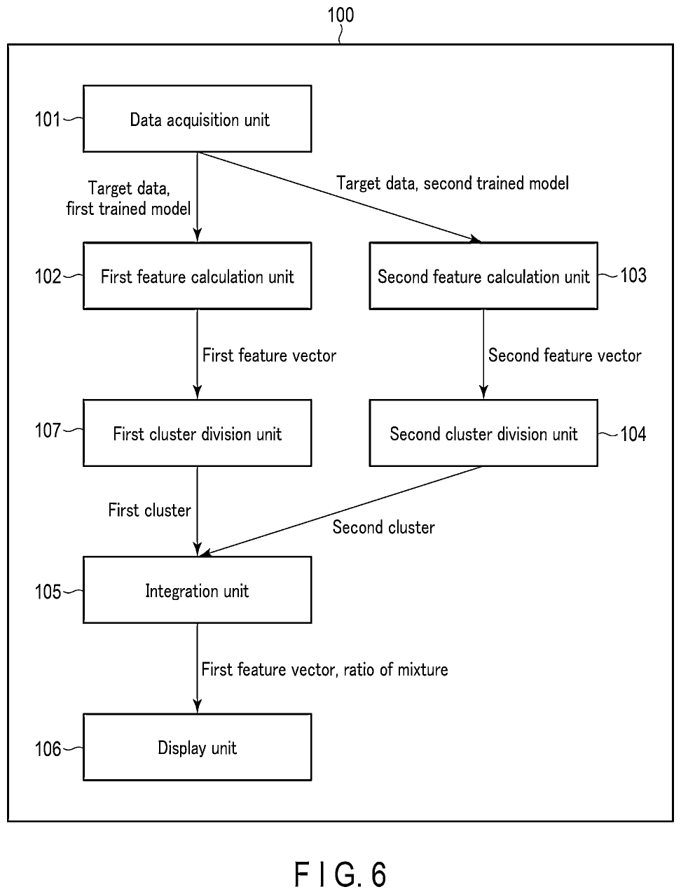

FIG. 6 is a diagram showing the configuration of the clustering apparatus 100 according to the present embodiment. The clustering apparatus 100 further includes a first cluster division unit 107. The first cluster division unit 107 performs clustering by dividing the first feature vectors calculated by the first feature calculation unit 102 and calculating the first clusters. For clustering, a general clustering method such as a k-means can be used. Various methods such as a centroid method and kernel density estimation can be applied to clustering.

The number of first clusters is preferably equal to the number of second clusters but may be different therefrom. For example, the number of first clusters may take a numerical value designated by a user.

The integration unit 105 integrates the first feature vectors with the second clusters by calculating a degree of mixing of the second clusters in a single first cluster of the first clusters. The degree of mixing is an index indicative of a degree of mixing of cluster IDs of the second clusters in a single first cluster. The degree of mixing increases in value as the number of second clusters to which pieces of target data in the single first cluster belong increases (the number of categories of second clusters increases). Examples of the degree of mixing include a reciprocal of the maximum ratio of second cluster IDs included in the first cluster, entropy of the distribution of the second clusters included in the first cluster, and the total number of second cluster IDs having a content rate of 3% or greater.

The degree of mixing decreases in value in a case where a plurality of pieces of target data that belong to the same first cluster are classified into the same second cluster. The degree of mixing increases in value in a case where the pieces of target data that belong to the same first cluster are classified into various second clusters. Therefore, the degree of mixing can also be referred to as an index indicative of the consistency and reproducibility of clustering results at the time when clustering is performed using a plurality of trained models.

The display unit 106 displays clustering results using the first trained model. At this time, the display unit 106 displays the clustering results using the first trained model based on an integration result by the integration unit 105. In the present embodiment, the display unit 106 displays a scatter diagram in which the first feature vectors are mapped, according to the degree of mixing in the first cluster to which the first feature vectors belong. At this time, the display unit 106 highlights the first feature vectors such that a difference in the calculated degree of mixing can be visually recognized. As a display method, for example, the first feature vector may be displayed in color using a color bar in accordance with the degree of mixing, and the size, color, shape, transparency, etc. of a point indicating each first feature vector may be displayed in accordance with the degree of mixing.

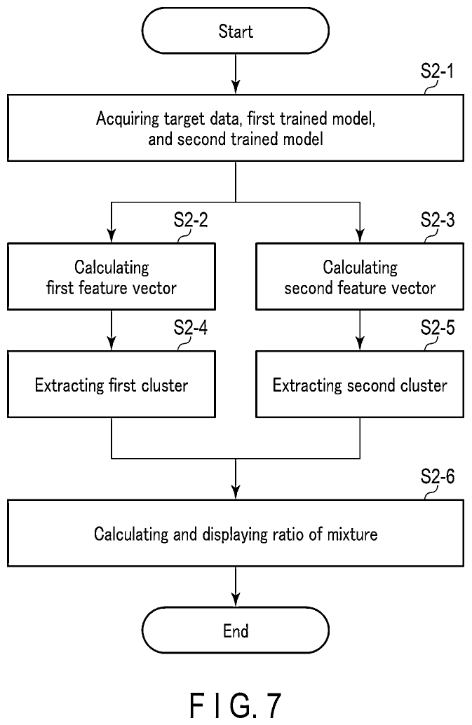

Next, the operation in the display processing executed by the clustering apparatus 100 according to the present embodiment will be described. FIG. 7 is a flowchart showing an example of a processing procedure in the display processing. Herein, as an example, a case will be described in which a model for clustering images each showing one of the multiple types of animals and serving as target data for each type of animal is used as a model to be trained.

Meanwhile, the processing in steps S2-1, S2-3, and S2-5 is the same as the processing in steps S1 to step S1-4 shown FIG. 2, and the explanations thereof will be omitted.

### (Steps S2-4)

The first cluster division unit 107 calculates the first clusters acquired by clustering the first feature vectors calculated by the first feature calculation unit 102. At this time, the first cluster division unit 107 divides the first feature vectors into clusters in 30 categories using an unsupervised clustering method such as a k-means.

### (Step S2-6)

The integration unit 105 integrates the first feature vectors with the second clusters. At this time, the integration unit 105 first acquires the first clusters extracted in the processing of step S2-4 with the second clusters extracted in the processing of step S2-5. Next, for each first cluster, the integration unit 105 extracts the second clusters to which pieces of target data included in the first cluster belong, and based on the number of extracted second clusters, calculates the degree of mixing of the second clusters in the first cluster concerned.

Next, based on an integration result, the display unit 106 displays a scatter diagram in which the first feature vectors are mapped. At this time, the display unit 106 displays each first feature vector in a manner according to the degree of mixing in the first cluster to which the first feature vector concerned belongs. For example, the shape, color, and size of a point indicating each first feature vector is changed according to the degree of mixing. This scatter diagram is used to check the clustering performance of the first trained model.

### Advantageous Effect of Second Embodiment

Hereinafter, the advantageous effects of the clustering apparatus 100 according to the present embodiment will be described below.

The clustering apparatus 100 according to the present embodiment further includes the first cluster division unit 107 in addition to the data acquisition unit 101, the first feature calculation unit 102, the second feature calculation unit 103, the second cluster division unit 104, the integration unit 105, and the display unit 106.

The first cluster division unit 107 calculates the first clusters by dividing the first feature vectors. For example, the number of first clusters is set to be equal to the number of second clusters. The integration unit 105 calculates the degree of second clusters in a single first cluster. The display unit 106 displays each first feature vector based on the degree of mixing in the corresponding first cluster.

With the above configuration, the clustering apparatus 100 according to the present embodiment can improve the visibility of clustering results by integrating the first feature vectors calculated using the first trained model with the second clusters calculated using the second trained model, calculating the degree of mixing of second clusters for each first cluster, and displaying each first feature vector according to the corresponding degree of mixing. A user can improve the efficiency of discussion and analysis of cluster results by checking a scatter diagram of the first feature vectors distinguished by color in accordance with the degree of mixing, for example.

Harmful data unsuitable for clustering is poor in consistency and reproducibility when clustering is performed using various trained models. For this reason, of the first clusters, the number of second clusters tends to increase in a first cluster including large harmful data unsuitable for clustering. Therefore, an image belonging to the first cluster having the low degree of mixing often exhibits an image pattern which allows the image to be easily clustered. On the other hand, an image belonging to the first cluster having the high degree of mixing often corresponds to harmful data unsuitable for clustering. Therefore, the degree of mixing of cluster IDs of the second clusters in each cluster of the first cluster may serve as an index to measure whether or not an image pattern of an image is a pattern that allows the image to be easily clustered. For example, a user can consider the first cluster exhibiting the high degree of mixing as a pseudo cluster composed of harmful data, and discuss and analyzes a clustering result without considering this pseudo cluster. As described above, by auxiliarily using output of the second trained model trained under conditions different from those of the first trained model, the visibility of clustering results of the first trained model can be improved. That is, by providing the clustering apparatus 100 using the first trained model with information on clustering results of the second trained model different from the first trained model, the clustering performance of the first trained model can be easily checked.

Furthermore, by setting the number of first clusters to be equal to the number of second clusters, a formula for calculating the degree of mixing can be simplified to reduce a time required for calculating the degree of mixing.

As described above, according to the present embodiment, by displaying a scatter diagram of the first feature vectors in accordance with the degree of mixing of the second clusters for each first cluster, the visibility of clustering results can be improved to improve the efficiency of discussion and analysis of cluster results.

### Modification of Second Embodiment

Meanwhile, of the pieces of target data, those exhibiting a certain degree or more of mixing may be presented to a user. For example, the display unit 106 extracts an image exhibiting a certain degree or more of mixing, and displays the extracted image as a thumbnail. The user can check harmful data efficiently by checking only images exhibiting the high degree of mixing.

Furthermore, target data to be assigned to the first cluster may be selected in accordance with the degree of mixing. For example, the display unit 106 extracts target data with a certain degree or lower of mixing and displays only the first feature vectors of the extracted pieces of target data on a scatter diagram. Target data with a high degree of mixing is not displayed on the scatter diagram of the first feature vectors. This can display the scatter diagram in which data that is highly likely to be harmful data is removed in advance.

Furthermore, the first clusters may be recalculated using the degree of mixing. For example, the first cluster division unit 107 adjusts the weight of the calculation for determining the center of gravity using the k-means method for each first feature vector to a value that is inversely proportional to the degree of mixing. Since target data with a high degree of mixing is highly likely to be harmful data, the influence of harmful data can be reduced by reducing the weight of the target data with a high degree of mixing at the time of calculating the first clusters.

Furthermore, the degree of mixing calculated using the first trained model and the second trained model may be used for training of another trained model. For example, a third trained model may be trained using target data and the degree of mixing of the target data. The third trained model is a machine learning model that receives input of target data and outputs a third feature vector. A target data with a high degree of mixing is highly likely to be harmful data. Thus, by performing training in consideration of the degree of mixing, the influence of a harmful target data with a high degree of mixing can be reduced, so that a trained model with high clustering performance can be generated.

Furthermore, the clustering apparatus 100 according to the present embodiment may include a retrieval function for retrieving data similar to predetermined data for retrieval (hereinafter referred to as “retrieval data”) from among pieces of target data. In this case, the clustering apparatus 100 further includes a retrieval unit configured to calculate a similarity between each piece of target data and the retrieval data, and to retrieve target data similar to the retrieval data (hereinafter referred to as “similar data”) based on the similarity of each piece of target data. The retrieval unit acquires, as a feature vector for retrieval (hereinafter referred to as a “retrieval feature vector”), the first feature vector or the second feature vector of the retrieval data by inputting predetermined data into the first trained model or the second trained model, and calculates a similarity between the acquired retrieval feature vector and the first feature vector or the second feature vector of each piece of target data. Thereafter, the retrieval unit extracts, as similarity data, target data with a degree of similarity equal to or greater than a threshold value, and presents the extracted similar data to a user.

Furthermore, in retrieving similar data, a retrieval result may be adjusted according to the degree of mixing of each piece of target data calculated by the integration unit. In such a case, the retrieval unit reduces the similarity of target data with a high degree of mixing, thereby making it difficult for the target data with a high degree of mixing to be extracted as similar data. Since target data with a high mixing degree is highly likely to be harmful data, the retrieval performance can be improved by reducing the influence of harmful data at the time of retrieving similar data.

### Modification of First Embodiment or Second Embodiment

The above embodiments described the case in which image data is used as target data; however, data in another format that can serve as a clustering target may also be used as target data. For example, audio data, table data, sensor data such as acceleration and voltage, etc. can be used as target data.

Furthermore, the above embodiments described the case in which a DNN is used as a trained model; however, another machine learning model that is usable for clustering may be used. Examples of the trained model include a multiple regression analysis model, an SVM, a decision tree model, etc.

Furthermore, the above embodiments described the case in which a single second trained model is used; however, a plurality of second trained models may be used. For example, a plurality of second clusters acquired from a plurality of second trained models may be integrated, and the first feature vectors in a scatter diagram may be displayed according to the integrated second cluster. Furthermore, the degree of mixing in the first feature vectors may be calculated using the integrated second cluster, and the first feature vectors in the scatter diagram may be displayed according to the degree of mixing. At the time of integrating the plurality of second clusters, it is preferable that a difference in training conditions between each second trained model and the first trained model be converted into a numerical value, and an integration ratio of each second cluster be adjusted according to the numerical value. Examples of the difference in training conditions from the first trained model include a difference in hyperparameters during training, a difference in the number of parameters related to a model architecture, etc.

### Applied Example

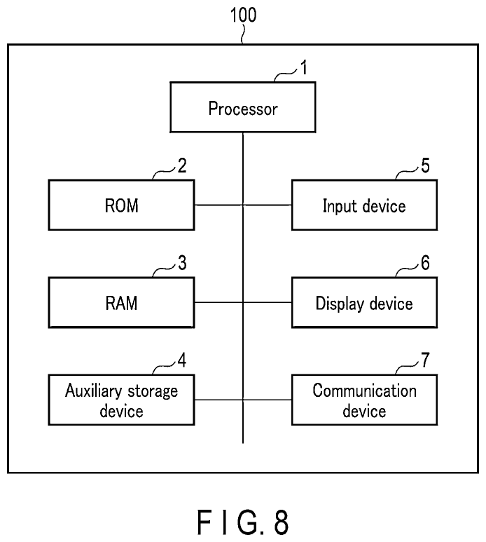

FIG. 8 is a diagram showing a hardware configuration of the clustering apparatus 100 shown in FIG. 1 and FIG. 6. As shown in FIG. 8, the clustering apparatus 100 is a computer including a processor 1, a read only memory (ROM) 2, a random access memory (RAM) 3, an auxiliary storage device 4, an input device 5, a display device 6, and a communication device 7. Transmission and reception of data and various signals between the processor 1, the ROM 2, the RAM 3, the auxiliary storage device 4, the input device 5, the display device 6, and the communication device 7 are performed via a bus.

The processor 1 is an integrated circuit configured to control the overall operation of the clustering apparatus 100. The processor 1 is an example of processing circuitry. For example, the processor 1 includes a central processing unit (CPU), a graphics processing unit (GPU), a digital signal processor (DSP), and/or a floating-point unit (FPU). The processor 1 may include an internal memory and an I/O interface. The processor 1 executes various types of processing by interpreting and computing programs stored in advance in the ROM 2, the auxiliary storage device 4, etc. The processor 1 may be partially or entirely realized by hardware such as an application specific integrated circuit (ASIC) or a field programmable gate array (FPGA), etc.

The ROM 2 is a nonvolatile memory configured to store various types of data. For example, the ROM 2 stores data, a setting value, etc., used by the processor 1 to execute various types of processing. The ROM 2 may include a non-transitory computer readable storage medium configured to store a program to be executed by the processor 1.

The RAM 3 is a volatile memory used for reading and writing data. The RAM 3 temporarily stores data used by the processor 1 to execute various types of processing. The RAM 3 provides a work area for the processor 1.

The auxiliary storage device 4 is a nonvolatile memory configured to store various types of data. For example, the auxiliary storage device 4 stores data and setting values used by the processor 1 to execute various types of processing, data generated by various types of processing by the processor 1, etc. The auxiliary storage device 4 is composed of a hard disk drive (HDD), a solid state drive (SSD), an integrated circuit storage device, etc. The auxiliary storage device 4 may include a non-transitory computer readable storage medium configured to store a program executed by the processor 1.

The input device 5 receives input of various operations from a user. As the input device 5, a keyboard, a mouse, various switches, a touch pad, a touch panel display, etc., can be used. An electrical signal (hereinafter referred to as an “operation signal”) corresponding to a received operation input is supplied to the processor 1.

The display device 6 displays various types of data under the control of the processor 1. As the display device 6, a cathode-ray tube (CRT) display, a liquid crystal display, an organic electro luminescence (EL) display, a light-emitting diode (LED) display, a plasma display, or any other display can be used as appropriate. The display device 6 may be a projector.

The communication device 7 includes a communication interface such as a network interface card (NIC) for performing data communication with various devices connected to the clustering apparatus 100 via a network. Note that an operation signal may be supplied from a computer connected via the communication device 7 or an input device included in the computer, and various types of data may be displayed on a display device, etc., included in the computer connected via the communication device 7. However, to simplify the following explanation, it is assumed that a source of the operation signal is the input device 5, and a display destination of the various types of data is the display device 6, unless otherwise specified. The input device 5 is replaceable with a computer connected via the communication device 7 or an input device included in the computer, and the display device 6 is replaceable with a display device, etc., included in the computer connected via the communication device 7.

The clustering apparatus 100 does not necessarily include all of the processor 1, the ROM 2, the RAM 3, the auxiliary storage device 4, the input device 5, the display device 6, and the communication device 7. Some of the processor 1, the ROM 2, the RAM 3, the auxiliary storage device 4, the input device 5, the display device 6, and the communication device 7 may not be provided as appropriate. The clustering apparatus 100 may be provided with any additional hardware device useful in performing the processing according to the present embodiment. The clustering apparatus 100 is not necessarily physically composed of one computer, but may be composed of a computer system having a plurality of computers communicatively connected via a wire, a network line, etc. The assignment of a series of processing according to the present embodiment to a plurality of processors 1 respectively installed in a plurality of computers can be freely set. All the processors 1 may execute the entirety of processing in parallel. Alternatively, one or some of the processors 1 may be assigned a specific part of the processing, and the series of processing according to the present embodiment may be executed as the entirety of the computer system.

Thus, according to any of the embodiments described above, it is possible to provide a clustering apparatus, a method, and a program which achieve improvement in visibility of clustering results or clustering performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A clustering apparatus comprising processing circuitry configured to:
acquire target data, a first trained model adapted to receive input of the target data and output a first feature vector, and a second trained model adapted to receive input of the target data and output a second feature vector;
calculate the first feature vector using the first trained model and the target data;
calculate the second feature vector using the second trained model and the target data;
calculate a second cluster by dividing the second feature vector; and
integrate the first feature vector with the second cluster.

2. The clustering apparatus according to claim 1, wherein the processing circuitry is configured to cause a display to display the first feature vector based on an index of the second cluster that corresponds to the first feature vector.

3. The clustering apparatus according to claim 1, wherein the first trained model and the second trained model differ from each other in a model architecture, a training method, a hyperparameter during training, or a training data set.

4. The clustering apparatus according to claim 1, wherein the processing circuitry is configured to:
calculate a first cluster by diving the first feature vector; and
calculate a degree of mixing of the second cluster in the first cluster.

5. The clustering apparatus according to claim 4, wherein the processing circuitry is configured to cause a display to display the first feature vector based on the degree of mixing in the first cluster that corresponds to the first feature vector.

6. The clustering apparatus according to claim 4, wherein the first cluster and the second cluster are each more than one and are equal in number.

7. The clustering apparatus according to claim 4, wherein the processing circuitry is configured to select the target data to be assigned to the first cluster, in accordance with the degree of mixing.

8. The clustering apparatus according to claim 4, wherein the processing circuitry is configured to train a third trained model based on the target data and the degree of mixing.

9. The clustering apparatus according to claim 4, wherein
the target data comprises a plurality of pieces of target data, and
the processing circuitry is configured to:
calculate, for each of the pieces of target data, a similarity between a retrieval feature vector acquired by inputting retrieval data to the first trained model or the second trained model and the first feature vector or the second feature vector;
retrieve for similar data similar to the retrieval data from among the pieces of target data based on the similarity; and
adjust a retrieval result in accordance with a degree of mixing of the pieces of target data.

10. The clustering apparatus according to claim 9, wherein the processing circuitry is configured to decrease the similarity for the target data of which degree of mixing is high.

11. The clustering apparatus according to claim 4, wherein the processing circuitry is configured to recalculate the first cluster using the degree of mixing.

12. A method comprising:
acquiring target data, a first trained model adapted to receive input of the target data and output a first feature vector, and a second trained model adapted to receive input of the target data and output a second feature vector;
calculating the first feature vector using the first trained model and the target data;
calculating the second feature vector using the second trained model and the target data;
calculating a second cluster by dividing the second feature vector; and
integrating the first feature vector with the second cluster.

13. A non-transitory computer-readable storage medium storing a program for causing a computer to execute:
acquiring target data, a first trained model adapted to receive input of the target data and output a first feature vector, and a second trained model adapted to receive input of the target data and output a second feature vector;
calculating the first feature vector using the first trained model and the target data;
calculating the second feature vector using the second trained model and the target data;
calculating a second cluster by dividing the second feature vector; and
integrating the first feature vector with the second cluster.
